(19) United States
(12) Patent Application Publication
(10) Pub. No.: US 2012/0081004 A1
(43) Pub. Date: Apr. 5, 2012

(54) Light emitting diode system

(76) Inventors: Thomas E. Wilmoth, Howell, MI (US); Willard A. Hall, Dryden, MI (US)

(21) Appl. No.: 13/199,164

(22) Filed: Aug. 22, 2011

Related U.S. Application Data
(60) Provisional application No. 61/404,220, filed on Sep. 30, 2010.

(51) Int. Cl. H01J 7/44

(52) U.S. Cl. 315/51

(57) ABSTRACT

An LED lighting device comprising a plurality of light-emitting diodes (LED) and a power supply that receives alternating-current (AC) power from an input node and provides rectified direct-current (DC) power to the LEDs. The LED lighting device further comprises a capacitive power-factor compensation means and a bridge rectifier, wherein the capacitive power-factor compensation means is electrically downstream from the input node and electrically upstream from the bridge rectifier, and wherein the bridge rectifier is electrically downstream from the capacitive power-factor compensator means and electrically upstream from the LEDs; and a heat sink that contains said power supply, wherein said heat sink comprises a plurality of carriers, on which the LEDs are mounted. The LED lighting device does not include an electronic module that performs digital computation of software.

### CROSS-REFERENCE TO RELATED APPLICATIONS

This application claims the benefit of Provisional Application No. 61/404,220, filed on Sep. 30, 2010. The disclosure of the above application is incorporated herein by reference.

### FIELD

The present invention relates to a light emitting diode (LED) system, and more particularly to an LED system with power factor modification.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

The goal of any light-emitting diode (LED) driver power supply is to successfully light an LED array to the desired level of intensity, while preventing the inherent tendency of an LED to thermally runaway and self destruct.

All presently known drivers for LED arrays which require more than a fraction of a watt of power utilize digital PWM control loops to achieve these objectives. Most known drivers use microprocessors. This approach requires a high component count which can lead to lower reliability, higher cost, and larger size.

This prior art provides acceptable levels of driver efficiency, but requires components whose cost and size are counter-productive to the application. Light bulbs come in standard sizes, the most common of which is the A19 (a normal 60 watt incandescent). The heat generated by the LEDs and driver must be dissipated into the environment, and in all known A19 form factor LED bulbs, the physical size of the driver forces the use of a glass dome as a part of the heat sink. The EMI/RFI generated by PWM power supplies is also a major issue.

The present invention employs innovative approaches described herein, and provides solutions counter-intuitive to the prior arts while resolving issues thereof. Advantageously, this invention provides an LED lighting system which has fewer components, is more reliable, and is less expensive.

Advantageously, this invention also provides an LED lighting system that generates no EMI/RFI and is safer to the environment. This invention also provides an LED light bulb, of which the bulb dome can be made of plastic material.

### SUMMARY

In one embodiment this disclosure describes an LED lighting device. The LED lighting device includes a plurality of light-emitting diodes (LED) and a power supply. The power supply receives alternating-current (AC) power from an input node and provides rectified direct-current (DC) power to the LEDs. The LED lighting device also includes a capacitive power-factor compensation means and a bridge rectifier. The capacitive power-factor compensation means is electrically downstream from the input node and electrically upstream from the bridge rectifier. The bridge rectifier is electrically downstream from the capacitive power-factor compensator means and electrically upstream from the LEDs. The LED lighting device also includes a heat sink. The heat sink contains the power supply, and the heat sink also includes a plurality of carriers. The LEDs are mounted on the carriers. The LED lighting device does not include an electronic module that performs digital computation of software or performs pulse-width modulation (PWM).

In another embodiment this disclosure describes an LED light bulb. The LED light bulb includes a plurality of light-emitting diodes (LED). The LED light bulb has a translucent dome that contains the LEDs. The translucent dome is made of plastic material. The LED light bulb includes a power supply. The power supply receives alternating-current (AC) power from an input node and provides rectified direct-current (DC) power to the LEDs. The LED light bulb includes a current-limiting circuit. The current-limiting circuit includes at least one reactive analog component. The LED light bulb also includes a bridge rectifier. The current-limiting circuit is electrically downstream from the input node and electrically upstream from the bridge rectifier. The bridge rectifier is electrically downstream from the current-limiting circuit and electrically upstream from the LEDs. The LED light bulb includes a heat sink. The heat sink contains the power supply. The heat sink includes a plurality of carriers. The LEDs are mounted on the carriers. The LED light bulb consists of only analog electronic components.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is an electrical schematic diagram of the LED bulb according to the principle of this invention;

FIG. 2 is a perspective view of an LED bulb according to the principle of this invention;

FIG. 3 is a cutaway view of the heat sink of the LED bulb according to the principle of this invention;

FIG. 4 is a perspective view of the LED mounting section of the heat sink according to the principle of this invention;

FIG. 5 is a perspective view of the LED carrier according to the principle of this invention; and

FIG. 6 is a perspective view of another embodiment of an LED bulb according to the principle of this invention.

### DETAILED DESCRIPTION

The following description is merely exemplary in nature and is in no way intended to limit the disclosure, its application, or uses. For purposes of clarity, the same reference numbers with or without a single or multiple prime symbols appended thereto will be used in the drawings to identify similar elements. It should be understood that steps within a method may be executed in different order without altering the principles of the present disclosure unless otherwise specified.

As used herein, the term module refers to an Application Specific Integrated Circuit (ASIC), an electronic circuit, a processor (shared, dedicated, or group) and memory that execute one or more software or firmware programs, a combinational logic circuit, and/or other suitable electrical or electronic components or devices that provide the described functionality.

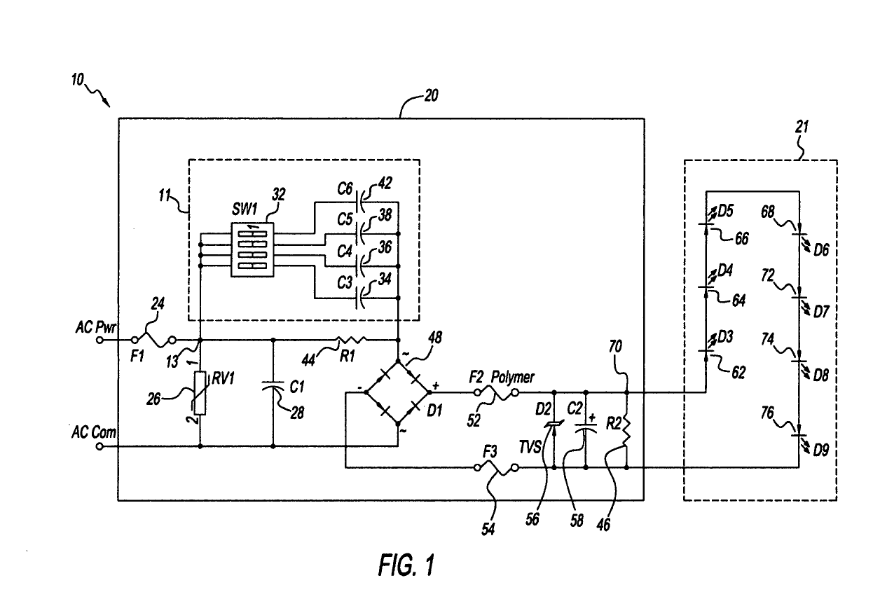

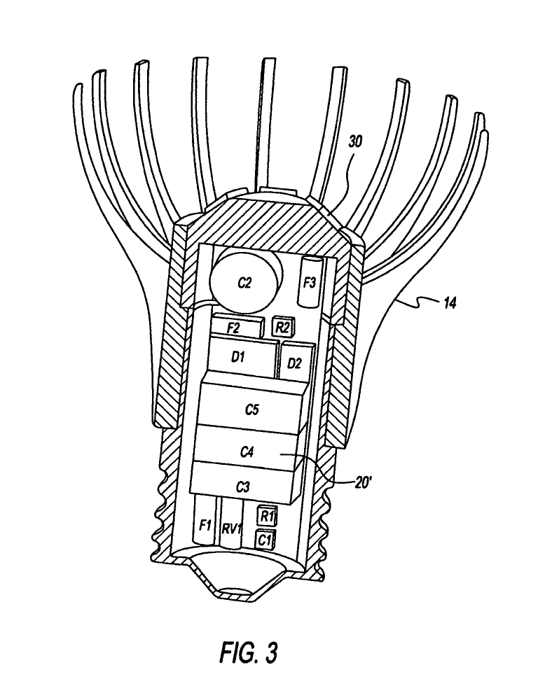

Referring now to FIG. 1, the schematic diagram of an LED bulb 10 is shown. The LED bulb 10 includes a power supply 20 and an LED array 21. The power supply 20 includes components used for any embodiment made according to the principles of this invention, for example, one illustrated in FIG. 3.

The power supply 20 may receive alternating current (AC) power from two terminals AC Pwr, AC Corn, and provide power needed for the LED lighting. The power supply 20 may include a conventional slow blow fuse 24 to prevent hazardous current flow in the case of any component failure. The power supply 20 may also include a metal oxide varistor 26 for protection against incidental high-voltage surge that may damage the power supply 20, such as lightening strikes, for example. The power supply 20 may also include a capacitor 28 for protection against input power surges.

The power supply 20 may include a current limiting circuit 11 electrically downstream from an input node 13, from which AC power flows into the power supply via the fuse 24. The current limiting circuit 11 may be a reactive current limiting circuit that contains a reactive component. The reactive component is an analog component according to the principle of this invention. The reactive current limiting circuit 11 may include typical analog components illustrated in the schematic diagram, which include an array of one or more capacitors, 34, 36, 38, 42, and a switch 32 which can be a hard wired mechanical switch, or any type of electronic switch. The switch 32 may be used to adjust the current limit to a desired value. The switch 32 may have an ON state and an OFF state, and control of the state can provide the effect of a “digital dimmer” that may be controlled by an external switch (not shown) available to an operator, or perhaps a detector of some sort (not shown) to determine if a room was occupied, and then turn the lights on. It is understood that the state of the switch 32 may be controlled via various external control means such as a local USB, WiFi, InfraRed, or other wired or wireless network (not shown).

The current limiting circuit 11 that contains a capacitor or capacitors, such as one or multiple of 34, 36, 38 or 42, provides power-factor compensation to the LED system according to the principle of the present invention. The current limiting circuit 11 of the power supply 20 generates capacitive reactance (current leading voltage) which can be used to compensate for the inductive reactance (voltage leading current) that is generated by various inductive loads present in the electric grid, such as electric motors, switched power supplies for electric appliances, for example. While most of the household appliances contribute inductive reactance to the electric grid, the power-factor compensation provided by the LED system of the present invention ameliorates the magnitude of electric grid power factor, resulting in an overall higher efficiency of the electric grid system. Therefore, this power-factor compensation mechanism provided by the current limiting circuit 11 modifies the power factor of the LED system, and can have a significant effect on the efficiency of the national power grid if significant numbers of these light bulbs are placed in service.

The values of the capacitors 34, 36, 38, and 42 may be selected based on the AC line voltage, the number of LEDs, and the desired selection of LED brightness versus LED operating life as determined by the objectives of the application and specific electrical characteristics of the LED. In one embodiment there is no switch or multiple capacitors, and only one capacitor 38 is hard wired to limit the current to the desired value. In other embodiments, the switch 32 may be present, and multiple capacitors may be included with values selected to allow for operation of a particular bulb on various AC line voltages while maintaining the desired current value.

The power supply 20 may include bleed resistors 44 and 46. The bleed resistors 44, 46 are not required in some embodiments, but are provided in this embodiment to eliminate any shock hazard when the LED bulb 10 is removed from its fixture. The power supply 20 may include a bridge rectifier 48 that converts input AC power to the DC power required by the LEDs 62, 64, 66, 68, 72, 74, 76. The bridge rectifier 48 is electrically downstream from the current limiting circuit 11. In the case of a change of the electrical load applied between the AC input terminals of the bridge rectifier 48 where excessive current may arise, the impedance of the current limiting circuit 11 may act as a current limited supply. This would typically occur during an attempted “thermal runaway” of the LEDs or the failure of the bridge rectifier 48, and the current limiting circuit 11 can protect the power supply 20 against such undesirable events.

The power supply 20 may include a polymer fuse 52 which serves multiple purposes. One primary use of the polymer fuse 52 is to protect the power supply 20 from inadvertant use with a Triac dimmer or other non-sine-wave AC power sources. Secondary uses include protection from an inadvertant connection of the positive side of LED power to the terminal of AC Com or earth ground, protection from input power surges, and protection from inadvertant use in excessive ambient temperature conditions. Current through the polymer fuse 52 generates heat which causes it to go into a self latching, high impedance “fuse mode” until the power is removed. As this protection is triggered by the sum of generated and ambient heat, the LEDs 62, 64, 66, 68, 72, 74, 76 will be protected under any operating conditions.

The power supply 20 may include a conventional fuse 54 to prevent hazardous current flow in the case of an inadvertant connection of the negative side of LED power to AC Com or earth ground. The power supply 20 may also include a transient voltage suppressor 56 that suppresses all voltage transients that exceed a threshold level (V_{TH}), which could damage the LEDs. The value of the threshold level (V_{TH}) may be selected based on the number of LEDs used and the sum of their working voltages. The transient voltage suppressor 56 also provides reverse bias protection. The power supply 20 may further include a filter capacitor 58 which is not required in all embodiments, but provided in this embodiment to eliminate any “flicker” of the light produced.

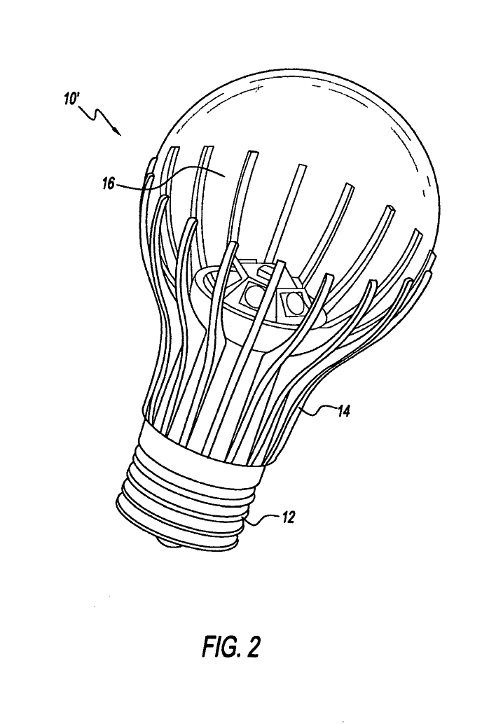

Referring also to FIG. 2, an overview of one embodiment of a LED bulb 10′ is shown. The LED bulb 10′ includes a screw base 12 and a translucent dome 16. The screw base 12 may be a conventional E26 screw base, and the translucent dome 16 may be in compliance with standards of A19 form factor. The translucent dome 16 may be made of plastic material. The LED bulb 10′ may include a heat sink 14 that supports the translucent dome 16. The heat sink 14 further contains the power supply 20 and provides mounting surfaces for the LEDs 62, 64, 66, 68, 72, 74, 76.

FIG. 3 shows a cutaway view of the heat sink 14 illustrated in FIG. 2 to expose the power supply 20′ which was discussed with FIG. 1. In this embodiment, the heat sink 14 consists of several parts that are mechanically bonded together. The several parts of the heat sink 14 may be formed using castings in other embodiments, but in any case, the screw base 12 forms a part of the heat sink path to dissipate heat generated within the LED bulb 10′. The heat sink 14 includes an LED mounting section 30 that supports the LEDs 62, 64, 66, 68, 72, 74, 76 and directs the generated heat to be dissipated.

Now also refer to FIG. 1 where the LED array 21 is shown. In this embodiment the LED array 21 contains seven LEDs, 62, 64, 66, 68, 72, 74, 76 connected in series. The LED array 21 is electrically downstream from, and receives DC power from a power output node 70 which is electrically downstream from the bridge rectifier 48. The number of LEDs selected may be determined by the desired lumen output and the capability of the heat sink 14. The heat sink capability is limited by the size of the bulb, airflow over the heatsink, and the ambient temperature. The maximum number of LEDs that can be controlled may depend on the input AC voltage.

The LED array 21 consists of only one set of LEDs 62, 64, 66, 68, 72, 74 connected in series, there is no other set of LEDs or any individual LED connected in parallel with the LED array 21. Under this electrical architecture, when a potential thermal runaway event arises in any of the individual LEDs, the current limiting effect of the electrical architecture provided by the LED array 21 in conjunction with the current limiting circuit 11 can limit the level of current flowing through the LEDs in series, thus preventing thermal runaway from taking place. As a result, even though each individual LED in series may exhibit an intrinsic variation during the manufacturing process, the thermal runaway of the LED bulb can be prevented with the electrical architecture disclosed in this invention.

It should be noted that the operation of LED lighting including achieving prevention of thermal runaway, according to the principle of this invention, does not employ any electronic module that performs digital computation, such as a microprocessor or imbedded system that requires digital signal processing and a timing clock for supervision of a control loop for execution of software. The LED lighting device does not perform pulse-width modulation (PWM). The LED bulb 10 contains only analog electronic components. The LED array 21 consists of only one set of LEDs connected in series without parallel connection to any other LED or set of LEDs.

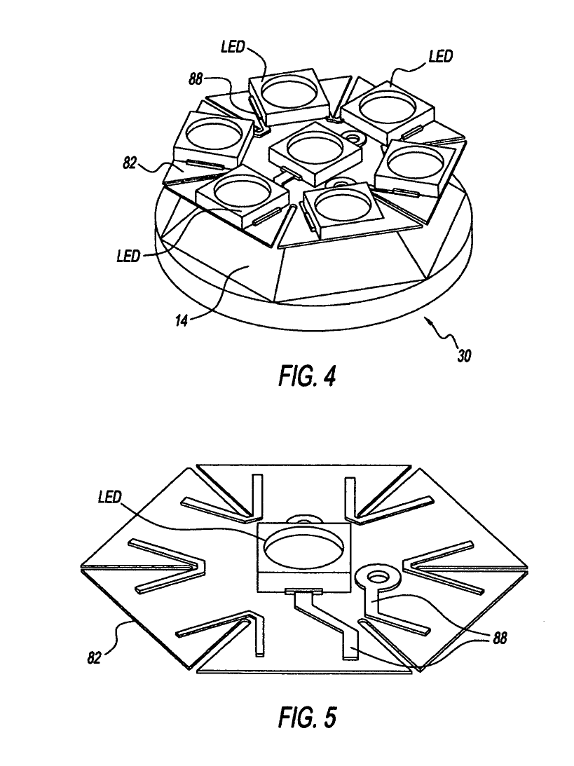

Referring now to FIG. 4 a perspective view of an LED mounting section 30 is shown. The mounting section 30 provides support to the LEDs 62, 64, 66, 68, 72, 74, 76 and the carriers 82. The mounting section 30 may include foils 88 on the carrier 82 to provide electrical conductivity for the LEDs 62, 64, 66, 68, 72, 74, 76. The LEDs 62, 64, 66, 68, 72, 74, 76 are soldered to foils 88 on the carrier 82 which is similar to a printed circuit board. The carrier 82 is then attached to the heat sink 14 by mechanical alignment as shown and pressure applied by tooling (not shown) which bends the carrier and aligns each LED 62, 64, 66, 68, 72, 74, 76 with its proper surface for bonding. Bonding can be accomplished by various means. One of the preferred means is by use of a heat sensitive carrier which, when cured, acts as both a mechanical bond and an electrical insulator. In any case, the mounting of the LED 62, 64, 66, 68, 72, 74, 76 and carrier 82 to the heat sink 14 is performed at a temperature and a cure time to assure quality bonding while avoiding damage to the LEDs 62, 64, 66, 68, 72, 74, 76. FIG. 5 illustrates one of the LEDs 62, 64, 66, 68, 72, 74, 76 attached to the carrier 82 by means of soldering to the foils 88.

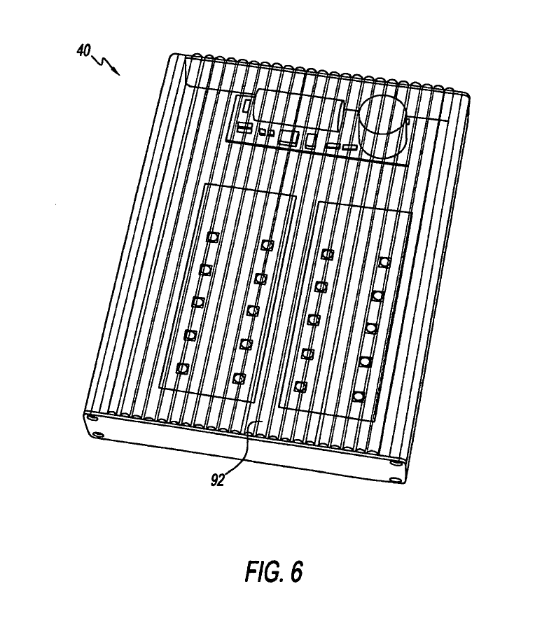

FIG. 6 shows a perspective view of another embodiment of LED bulb 40. This embodiment of LED bulb 40 includes a translucent lens cover 92, and allows the use of more LEDs for higher lumen output due to its larger heat sink (not shown). The power supply for this embodiment shares the same schematic with some components deleted and more LEDs added.

The broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification, and the following claims.

What is claimed is:

1. An LED lighting device comprising:
a plurality of light-emitting diodes (LED);
a power supply that receives alternating-current (AC) power from an input node and provides rectified direct-current (DC) power to the LEDs comprising:
a capacitive power-factor compensation means, and
a bridge rectifier;
wherein the capacitive power-factor compensation means is electrically downstream from the input node and electrically upstream from the bridge rectifier, and
wherein the bridge rectifier is electrically downstream from the capacitive power-factor compensator means and electrically upstream from the LEDs; and
a heat sink that contains said power supply, wherein said heat sink comprises a plurality of carriers, on which the LEDs are mounted; and
wherein the LED lighting device does not include an electronic module that performs digital software computations.

2. An LED lighting device of claim 1, wherein the plurality of LEDs are connected in series.

3. An LED lighting device of claim 1, wherein the capacitive power-factor compensation means comprises a capacitor.

4. An LED lighting device of claim 1, wherein the capacitive power-factor compensation means includes at least two capacitor-switch circuits, wherein each of the circuits comprises a switch and a capacitor connected in series, and wherein the two capacitor-switch circuits are connected in parallel.

5. An LED lighting device of claim 4, wherein the switches are controllable by external control means.

6. An LED light bulb comprising:
a plurality of light-emitting diodes (LED);
a translucent dome containing the LEDs, wherein the translucent dome is made of plastic material;
a power supply that receives alternating-current (AC) power from an input node and provides rectified direct-current (DC) power to the LEDs comprising:
a current-limiting circuit, wherein the circuit comprises at least one reactive analog component, and
a bridge rectifier;
wherein the current-limiting circuit is electrically downstream from the input node and electrically upstream from the bridge rectifier, and
wherein the bridge rectifier is electrically downstream from the current-limiting circuit and electrically upstream from the LEDs; and
a heat sink that contains said power supply, wherein said heat sink comprises a plurality of carriers, on which the LEDs are mounted; and
wherein the LED light bulb consists of only analog electronic components.

7. An LED light bulb of claim 6, wherein the plurality of LEDs are connected in series.

8. An LED light bulb of claim 6, wherein the reactive analog component is a capacitor.

9. An LED light bulb of claim 6, wherein the current-limiting circuit includes at least two capacitor-switch branches, wherein each of the branches comprises a switch and a capacitor connected in series, and wherein the two capacitor-switch branches are connected in parallel.

10. An LED light bulb of claim 9, wherein the switches are controllable by external control means.
